(19) United States
(12) Patent Application Publication
(10) Pub. No.: US 2005/0056799 A1
(43) Pub. Date: Mar. 17, 2005

(54) Valves having a thermostatic actuator controlled by a peltier device

(76) Inventor: Steven J. Malone, Provo, UT (US)

Correspondence Address: Angus C. Fox, III, 4093 N. Imperial Way, Provo, UT, 84604-5386, US

(21) Appl. No.: 10/940,068

(22) Filed: Sep. 13, 2004

Related U.S. Application Data
(60) Provisional application No. 60/502,057, filed on Sep. 11, 2003.

(51) Int. Cl. F16K 31/00

(52) U.S. Cl. 251/11

(57) ABSTRACT

An electro-thermostatic expansion valve (ETXV) includes a valve body having a thermostatic actuator controlled by a Peltier thermoelectric module. The valve may be electronically controlled in response to measured parameters at critical locations in refrigeration, heating, pneumatic and hydraulic systems. A preferred method of controlling the ETXV valve involves the use of pressure or temperature sensors located on the expansion head of the ETXV or on an external device controlled by the ETXV. The sensors provide feedback signals to a micro-controller, and the micro-controller directly controls the thermoelectric module. An alternate method of controlling the new ETXV involves the use of operator inputs provided to a micro-controller which controls the thermoelectric module. The operator can manually adjust the micro-controller in response to observed process parameters. The ETXV can be configured to use one or both sides of the thermoelectric module to control the valve actuator.

This application has a priority date based on Provisional Patent Application No. 60/502,057, which was filed on Sep. 11, 2003.

### BACKGROUND OF THE INVENTION

1. Field of the Invention

This invention relates generally to valves for controlling the flow of fluids and gasses. More particularly, this invention relates to a low-power electronically controlled valve that is particularly useful for proportional flow control of liquids such as those used in refrigerant applications.

2. Description of the Prior Art

Inexpensive electronic control of refrigerant expansion does not presently exist. Most contemporary refrigeration systems use a mechanically-controlled thermal expansion valve (TXV). Electronic control is superior to mechanical control in many ways. User control of evaporator pressure/temperature set points, superheat loading of the compressor, and greater general pressure/temperature stability make an electronically-controlled thermal expansion valve (EXV) far superior to a mechanical TXV. Current EXVs are expensive, and typically utilize an electronically-controlled stepper motor that actuates the valve. Refrigerative cooling could be made vastly more energy efficient for many applications if less expensive EXVs were available. Valve flow could be controlled as a function of evaporator temperature set points. In a car, for example, the interior air temperature could be controlled varying the flow of refrigerant fluid, without repeatedly turning the compressor on and off. Without the need to turn the compressor on and off when set points are reached, the temperature could be maintained within a much narrower range. When the heat load in the car is reduced, the EXV could decrease the load on the compressor, thereby decreasing fuel consumption by the engine. EXVs have never been used in cars because of their size and cost. Superheat compressor loading is an important issue for large and specialized refrigeration systems, and especially those which must maintain a temperature setting below −40° Celsius/Fahrenheit. Such systems would benefit greatly from the variable superheat loading that EXVs make possible. For example, if the system needs to achieve a temperature setting of −40° Fahrenheit/Celsius, and the ambient temperature at the evaporator is 60° Fahrenheit (about 15.6° Celsius), a compressor controlled by a TXV will have a huge initial heat load. Consequently, the compressor is subjected to a high degree of mechanical and electrical stress as it consumes large quantities of electrical energy. The heat load, of course, drops as the evaporator temperature approaches −40° Fahrenheit/Celsius. An EXV, on the other hand, could slowly adjust the superheat of the refrigeration system based on the evaporator heat load in order to maintain an ideal superheat condition. In order to accomplish this task, the EXV would adjust the evaporator pressure as a function of the evaporator temperature. As the evaporator temperature approaches the set point, the EXV would proportionally and progressively decrease the evaporator pressure for maximum latent heat transfer. Use of an EXV would result in the expansion of increased amounts of refrigerant, as the EXV will be open more of the time during ramp down to the set point. This mode of operation would facilitate more complete evaporation of the refrigerant and would allow the compressor to operate under a smaller heat load, thereby accomplishing greater heat transfer in a shorter period of time, with reduced energy consumption. Temperature stability of a refrigeration system is dependent on many variables, including contamination of the system, heat dissipation at the condenser, the heat load of the evaporator, and the stability of the refrigerant metering device. Use of an EXV would enhance system flexibility, which would allow the system to deal more effectively with the factors affecting temperature stability.

U.S. Pat. No. 6,129,331 to Henning, et al. Discloses a thermopneumatic valve having a fluid channel plate defining a fluid port. A diaphragm plate is attached to the fluid channel plate. The diaphragm plate includes a displaceable diaphragm to selectively obstruct the fluid port of the fluid channel plate. A thermal isolating heater is connected to the diaphragm plate. The thermal isolating heater includes a thermal isolating heater body with a heating surface, a perimeter wall defining an extended axial cavity to confine a thermopneumatic working fluid that is used to control the position of the displaceable diaphragm, and a diaphragm obstruction structure to limit the motion of the displaceable diaphragm into the extended axial cavity. The inventors suggest that the valve may be used to control refrigeration processes. As the thermal isolating heater is of the resistance wiring type, considerable [symbol] is required to actuate the valve.

Therefore, it can be appreciated that there exists a need for a new low-cost electronically-controlled expansion valve that requires much less operating [symbol] than the Henning, et al. valve heretofore described. Such a valve has the potential to revolutionize the control of [symbol] . In this regard, the present invention substantially fulfills this need.

### SUMMARY OF THE INVENTION

In the view of the disadvantages inherent in the known types of thermal expansion valves, the present invention provides an electronically-controlled thermal expansion valve having an thermostatic actuator controlled by a Peltier thermoelectric module. Such an electro-thermostatic expansion valve (ETXV) may be used to control refrigeration, heating, pneumatic and hydraulic systems.

A preferred method of controlling the new ETXV valve involves the use of pressure or temperature sensors located on the expansion head of the ETXV or on an external device controlled by the ETXV. The sensors provide feedback signals to a micro-controller, and the micro-controller directly controls the thermoelectric module. An alternate method of controlling the new ETXV involves the use of operator inputs provided to a micro-controller which controls the thermoelectric module. The operator can manually adjust the micro-controller in response to observed process parameters.

The new ETXV can be configured in at least several different ways. A first configuration employs an embedded thermoelectric module utilizing both sides of the module to control a differential pressure actuator. By using both the heat-sink side and the heat-source side of the module in combination with the differential pressure actuator, reaction time in response to received inputs can be reduced. A second configuration employs only the heat-sink side of the thermoelectric module to control the valve actuator. A third configuration employs only the heat-source side of the thermoelectric module to control the valve actuator. A fourth configuration employs an external thermoelectric module having an embedded thermostatic expansion bulb connected to the valve actuator by means of a capillary tube. This configuration is preferred when heat transfer from the valve will overpower the heating or cooling effect of the thermoelectric module.

### BRIEF DESCRIPTION OF THE DRAWINGS

FIG. 1 is a diagramatic view of an expansion valve having a thermostatic actuator controlled by both sides of a Peltier module;

FIG. 2 is a diagramatic view of an expansion valve having a thermostatic actuator controlled by the heat-source side of a peltier module;

FIG. 3 is a diagramatic view of an expansion valve having an external thermoelectric module with an embedded thermostatic expansion bulb connected to the valve by means of a capillary tube;

FIG. 4 is a diagramatic view of the expansion valve of U.S. Pat. No. 6,129,331, modified in accordance with the present invention to have a Peltier device in place of a thermal isolating heater;

FIG. 5 is a diagramatic view of a closed-loop refrigeration control system providing pressure and temperature feedback to a micro-controller that controlls refrigerant flow through an ETXV; and

FIG. 6 is a diagramtic view of an open-loop refrigeration control system that operates on user inputs.

### DETAILED DESCRIPTION OF THE INVENTION

The peltier Effect was discovered in 1834 by French watchmaker and physicist Jean Charles Athanase Peltier. The Peltier Effect occurs when electric current passes through the junction of two dissimilar conductors (a couple). Depending on the direction of the current, the junction is either cooled or heated. Semiconductors doped both p and n form the elements of the couple and are typically soldered to copper connecting strips. Bismuth telluride is typically used as the semiconductor material, as it shows the most pronounced Peltier effect at moderate operating temperatures. Ceramic faceplates electrically insulate these connecting strips from external surfaces. At open circuit, a temperature gradient maintained across the device creates a potential across its terminals proportional to the temperature differential. If the temperature differential is maintained, and if the device is connected to an electrical load, power will be generated. On the other hand, if the device is connected to a DC source, heat will be absorbed to one end of the device, thereby cooling it, while heat is expelled at the other end, where the temperature rises. A reversal of the current causes a reversal of the heat flow. A Peltier device can, therefore, be used to generate electric power or, depending on the polarity of its connection to external circuitry, heat or cool an object. A Peltier device only transfers or pumps heat from one of its sides to the opposite side. At the hot side, the heat must be removed through the use of a heat sink or by some other means. Heat delivered to the hot side of the device includes the pumped heat plus the heat resulting from electrical power dissipated within the device.

Although thermostatic actuators are well known in the art, Peltier devices have not, heretofore, been used to control them. The present invention makes use of Peltier devices to control thermostatic actuators, which can be coupled to valves or switches.

The invention will now be described with reference to the attached drawing figures. It should be understood that the drawings are simiplified schematic views, are not necessarily drawn to scale and are intended to be merely illustrative of the invention.

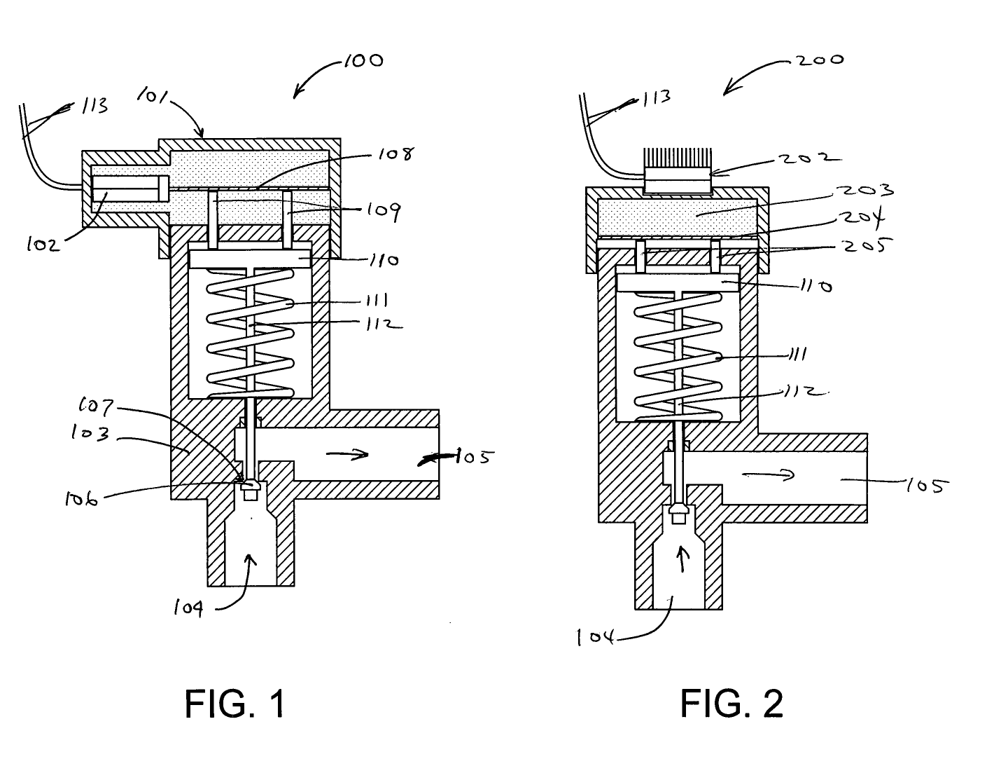

Referring now to FIG. 1, a first embodiment expansion valve 100, having a thermostatic actuator 101 controlled by both sides of a Peltier module 102, is shown. The valve 100 has a valve body 103 with an inlet 104, and an outlet 105. The passageway 106 between the inlet 104 and the outlet 105 is controlled by a conical valve plunger 106. The conical valve plunger 106 is normally pressed against the valve seat 107, but is pushed away from the seat by the expansion and contraction of gases brought about by current passing through the Peltier module 102. Gas on the top of the diaphragm 108 is exposed to the heat-source side of the Peltier module 102, while gas below the diaphragm 108 is exposed to the heat-sink side of the Peltier module 102. When current passes throught the Peltier module 102, the diaphragm 108 presses against the actuator pins 109, which in turn press on the actuator disk 110, thereby overcoming the force exerted by the coil spring 111 and depressing the vertical connector rod 112 that is directly coupled to the valve plunger 106. The wires 113 connect the Peltier module to an electronic control module (not shown in this view) which preferably includes a micro-controller.

Referring now to FIG. 2, a second embodiment expansion valve 200 having a thermostatic actuator 201 controlled by both sides of a Peltier module 202, is shown. The lower portion of the expansion valve is identical to that of FIG. 1. However, it will be noted that there is a gas reservoir 203 only on top of the diaphragm 204. When the Peltier module 202 heats gas within the gas reservoir 203, the diaphragm 204 presses against the actuator pins 205, which in turn press on the actuator disk 110, thereby overcoming the force exerted by the coil spring 111 and depressing the vertical connector rod 112 that is directly coupled to the valve plunger 106.

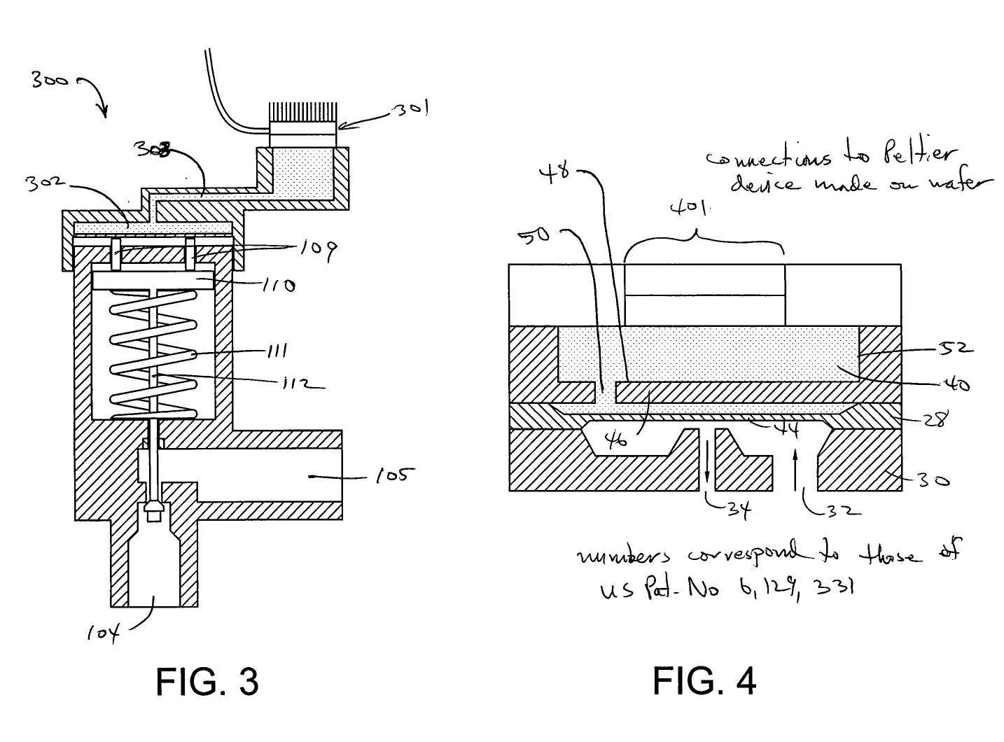

Referring now to FIG. 3, a third embodiment expansion valve 300 has an external Peltier module 301 with an embedded thermostatic expansion bulb 302 connected to the valve by means of a capillary tube 303. Such a configuration is useful when the heat loss through the valve is greater than the heat that a Peltier module directly coupled to the valve could generate. By isolating the Peltier module 301 from the valve, the valve may be operated using reduced power requirements.

Referring now to FIG. 4, the valve of U.S. Pat. No. 6,129,331 has been modified in accordance with the present invention to have a Peltier device 401 in place of a thermal isolating heater. U.S. Pat. No. 6,129,331 is hereby incorporated by reference into the present document.

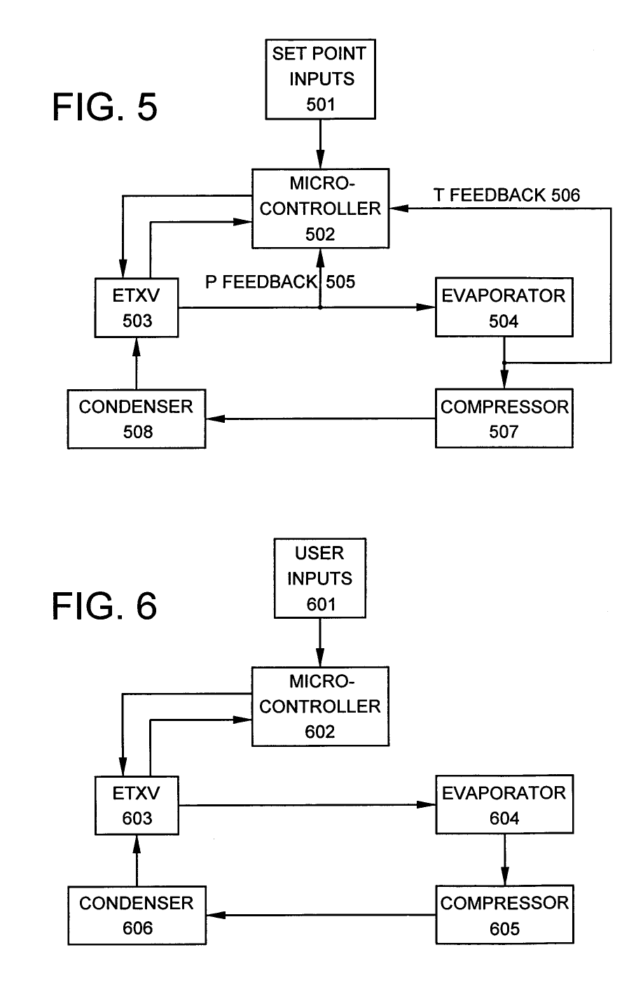

FIG. 5 is a diagramatic view of a closed-loop refrigeration control system 500. The system 500 includes a mirco-controller 502 having set point inputs 501, an electronically-contolled thermal expansion valve 503 incorporating a Peltier module, an evaporator 504, a compressor 507, and a condenser 508. Pressure feedback 505 from the front side of the evaporator 504 and temperature feedback 506 from the back side of the evaporator 504 are provided to the micro-controller 502 in order to maintain the thermal expansion valve 503 at optimum setting for efficient cooling with minimum energy expenditure.

FIG. 6 is a diagramtic view of an open-loop refrigeration control system 600 that operates on user inputs. The system 600 includes a mirco-controller 602 receiving user inputs 601, an electronically-contolled thermal expansion valve 603 incorporating a Peltier module, an evaporator 604, a compressor 605, and a condenser 606.

Although only several embodiments of the invention have been shown and described, it will be obvious to those having ordinary skill in the art that changes and modifications may be made thereto without departing from the scope and the spirit of the invention as hereinafter claimed.

1. A thermal expansion valve comprising:
a valve body having an inlet and an outlet;
a thermostatic actuator; and
a Peltier module by means of which the thermostatic actuator is electronically controlled.
